(19) United States
(12) Patent Application Publication
(10) Pub. No.: US 2026/0046982 A1
(43) Pub. Date: Feb. 12, 2026

(54) HEATER, AND FLUID HEATING DEVICE

(71) Applicant: Toshiba Lighting & Technology Corporation, Kanagawa (JP)

(72) Inventors: Kairi TAMURA, Ehime-ken (JP); Makoto SAKAI, Ehime-ken (JP); Masahiko TAMAI, Ehime-ken (JP); Tsuyoshi OHASHI, Ehime-ken (JP); Satoko KATO, Ehime-ken (JP); Akio TSUBOUCHI, Ehime-ken (JP); Kousuke UENO, Ehime-ken (JP); Masahiro DOI, Ehime-ken (JP); Yumi MINEYAMA, Ehime-ken (JP); Yoshihiro KUSUHASHI, Ehime-ken (JP)

(73) Assignee: Toshiba Lighting & Technology Corporation, Kanagawa (JP)

(21) Appl. No.: 19/019,499

(22) Filed: Jan. 14, 2025

(30) Foreign Application Priority Data
Aug. 6, 2024 (JP) 2024-130153

(51) Int. Cl. H05B 3/16; F24H 9/00

(52) U.S. Cl. CPC H05B 3/16; F24H 9/0015; F24H 9/0063

(57) ABSTRACT

A heater according to the embodiment is a heater that contacts with a relatively flowing fluid and heats the contacted fluid. The heater includes: a base portion presenting a plate-like shape, having a first surface which is a convex curved surface and a second surface which faces the first surface and is a concave curved surface, and the base portion being three-dimensionally bent; and at least one heating portion provided on at least one of the first surface side of the base portion and the second surface side of the base portion.

### CROSS-REFERENCE TO RELATED APPLICATION

This application claims the priority benefits of Japanese application no. 2024-130153, filed on Aug. 6, 2024. The entirety of the above-mentioned patent application is hereby incorporated by reference herein and made a part of this specification.

### BACKGROUND

### Technical Field

The disclosure relates to a heater and a fluid heating device.

### Description of Related Art

There is a heater that heats fluids such as air and water. The heater for heating fluids is, for example, provided in a hot air device that heats air, or provided in a hot water device that heats water.

As such a heater, for example, a PTC (positive temperature coefficient) heater has been proposed. When current flows through the PTC heater, the temperature of the PTC heater rises according to the magnitude of the current. And when the temperature of the PTC heater exceeds the Curie temperature, the resistance value of the PTC heater becomes high, making it difficult for current to flow through the PTC heater, and the temperature rise of the PTC heater is suppressed. As the temperature rise of the PTC heater is suppressed and the temperature of the PTC heater decreases, it becomes easier for current to flow through the PTC heater, and the temperature of the PTC heater rises again. Thus, by using a PTC heater, the heating temperature may be self-controlled.

However, the heat generated in the PTC heater is transferred to the fluid through the heat exchange fin. The heat exchange fin has multiple plate materials arranged three-dimensionally, thus, when using a PTC heater, there is a problem that miniaturization becomes difficult.

Also, a heater that heats solids such as toner by thermal conduction has been proposed. Such a heater has a plate-shaped base portion extending in one direction and a heating portion provided on one surface of the base portion. Thus, in the case where a heater having a plate-shaped base portion is used for heating fluid, miniaturization may be achieved.

However, when using a heater having a flat plate-shaped base portion for heating a fluid, there is a problem that it becomes difficult to improve the heating efficiency of the fluid.

Thus, the development of a technology that may achieve miniaturization and improve the heating efficiency of the fluid is desired.

### RELATED ART DOCUMENTS

### Patent Document

[Patent Document 1] Japanese Patent Application Laid-Open (JP-A) No. 2020-059368.

[Patent Document 2] Japanese Patent Application Laid-Open (JP-A) No. 2015-197971.

The problem to be solved by the disclosure is to provide a heater and a fluid heating device that may achieve miniaturization and improve the heating efficiency of the fluid.

### SUMMARY

The heater according to the embodiment is a heater that contacts with a relatively flowing fluid and heats the contacted fluid. The heater includes a base portion presenting a plate-like shape, having a first surface which is a convex curved surface and a second surface which faces the first surface and is a concave curved surface, and the base portion being three-dimensionally bent; and at least one heating portion provided on at least one of the first surface side of the base portion and the second surface side of the base portion.

### BRIEF DESCRIPTION OF THE DRAWINGS

FIG. 1 is a schematic perspective view illustrating the heater related to the embodiment.

FIG. 2 is a schematic view illustrating the effect of the heater related to a comparative example.

FIG. 3 is a schematic view illustrating the effect of the heater.

FIG. 4 is a schematic perspective view illustrating the heater related to another embodiment.

FIG. 5 is a schematic view illustrating the fluid heating device related to the embodiment.

FIG. 6 is a schematic view illustrating the fluid heating device related to another embodiment.

FIG. 7 is a schematic view illustrating the arrangement form of the heater.

### DESCRIPTION OF THE EMBODIMENTS

According to an embodiment of the disclosure, a heater and a fluid heating device may be provided that may achieve miniaturization and improve the heating efficiency of the fluid.

The embodiment will be described below with reference to the drawings. It is noted that in each drawing, the same reference numerals are assigned to similar components, and detailed descriptions are omitted as appropriate.

### Heater

The heater 1 related to this embodiment contacts with a fluid that flows relatively to the heater 1, and heats the fluid that it contacts. For example, the heater 1 heats the flowing fluid by being immersed in the flowing fluid. For example, the heater 1 causes the fluid to flow and simultaneously heats the fluid by moving within the fluid.

The fluid may be, for example, a gas (such as air) included in the environment where the heater 1 is provided, or a liquid such as water or a solution (for example, coolant liquid and the like). However, the types of fluid are not limited to those illustrated.

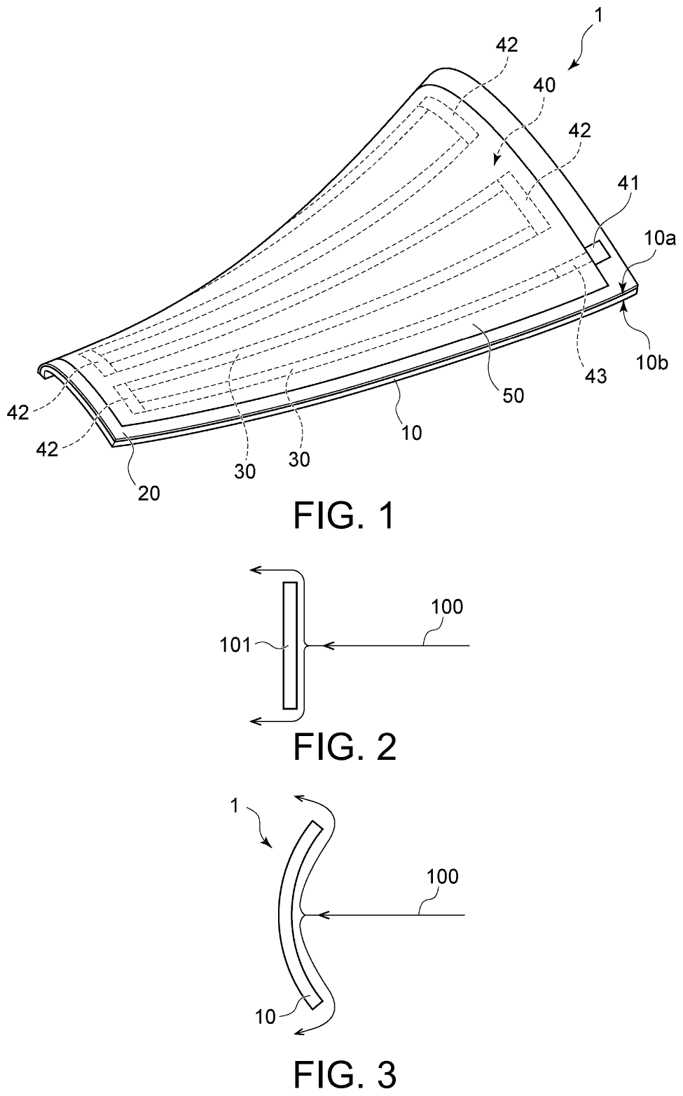

FIG. 1 is a schematic perspective view illustrating the heater 1 related to the embodiment. As shown in FIG. 1, the heater 1 has, for example, a base portion 10, an insulation portion 20, a heating portion 30, a wiring portion 40, and a protection portion 50.

As shown in FIG. 1, the base portion 10 is, for example, plate-shaped and extends in one direction. The base portion 10 has, for example, a surface 10a (corresponding to an example of a first surface) and a surface 10b (corresponding to an example of a second surface) facing the surface 10a. For example, the surface 10a may be a convex curved surface. For example, the surface 10b may be a concave curved surface.

The base portion 10 is, for example, three-dimensionally bent. For example, the surface 10a has a curved outline when projected onto a horizontal plane and a curved outline when projected onto a vertical plane. For example, the surface 10b has a curved outline when projected onto a horizontal plane and a curved outline when projected onto a vertical plane. In this case, the surface 10b is bent following the surface 10a. At least in the region where the heating portion 30 is provided, the distance (thickness) between the surface 10a and the surface 10b is substantially constant.

In the direction in which the base portion 10 extends, the dimension of one end of the surface 10a may be the same as or different from the dimension of the other end of the surface 10a. In the case of the heater 1 illustrated in FIG. 1, the dimension of one end of the surface 10a is different from the dimension of the other end of the surface 10a.

In the direction in which the base portion 10 extends, the dimension of one end of the surface 10b may be the same as or different from the dimension of the other end of the surface 10b. In the case of the heater 1 illustrated in FIG. 1, the dimension of one end of the surface 10b is different from the dimension of the other end of the surface 10b.

For example, the dimension of the part of surface 10b facing surface 10a may be made substantially the same as the dimension of surface 10a.

The base portion 10 is formed from a material having heat resistance and high thermal conductivity. For example, the base portion 10 may be formed from metal such as stainless steel or aluminum alloy, or inorganic material such as ceramics.

Here, the thermal conductivity of metal is higher than that of inorganic materials such as ceramics. Thus, in the case where the base portion 10 is formed from metal, the heating time of the heater 1 may be shortened. Moreover, the rigidity of metal is higher than that of inorganic materials such as ceramics. Thus, in the case where the base portion 10 is formed from metal, the rigidity of the heater 1 may be improved. In the case where the rigidity of the heater 1 is increased, it is possible to increase the flow rate or flow velocity of the fluid flowing relative to the heater 1, or to increase the viscosity or density of the fluid. As a result, the processing capacity of the fluid heating device 200 and 200a described later may be improved, or the types of fluids to be heated may be increased. Further, the longevity of the heater 1 may be enhanced.

Further, in the case where the base portion 10 is formed from metal, the base portion 10 may be formed by plastic working such as press working. Thus, it is possible to attempt to reduce the manufacturing cost of the base portion 10, and consequently, to reduce the manufacturing cost of the heater 1.

On the other hand, inorganic materials such as ceramics generally have insulating properties. Thus, in the case where the base portion 10 is formed from an inorganic material, the insulation portion 20 to be described later may be omitted. For example, in the case where the base portion 10 is formed from a material having insulating properties, the heating portion 30 and the wiring portion 40 may be directly provided on the base portion 10.

It is noted that, the heater 1 illustrated in FIG. 1 has a base portion 10 containing metal and an insulation portion 20 provided between the heating portion 30 and the base portion 10.

The insulation portion 20, the heating portion 30, the wiring portion 40, and the protection portion 50 may be provided on at least one of the surface 10a of the base portion 10 and the surface 10b of the base portion 10. In the heater 1 illustrated in FIG. 1, the insulation portion 20, the heating portion 30, the wiring portion 40, and the protection portion 50 are provided on the surface 10a of the base portion 10. In the following, as an example, a case where the insulation portion 20, the heating portion 30, the wiring portion 40, and the protection portion 50 are provided on the surface 10a of the base portion 10 is described.

The insulation portion 20 is provided to insulate between the conductive base portion 10 and the heating portion 30 and the wiring portion 40. Thus, the insulation portion 20 covers at least the region where the heating portion 30 and the wiring portion 40 are provided on the surface 10a of the base portion 10. In the heater 1 illustrated in FIG. 1, the insulation portion 20 covers the entire region of the surface 10a of the base portion 10. The thickness of the insulation portion 20 is not particularly limited as long as insulation may be ensured. The insulation portion 20 is formed from a material having heat resistance and insulation properties. The insulation portion 20 may be formed from, for example, ceramics or glass material. The insulation portion 20 may be formed by, for example, thermal spraying or firing.

The heating portion 30 converts applied electrical power into heat (Joule heat). The heating portion 30 is provided on the surface 10a of the base portion 10 via the insulation portion 20. It is noted that in cases where the base portion 10 is formed from a material having insulating properties, the heating portion 30 may be provided directly on the surface 10a of the base portion 10.

The heating portion 30 presents a linear shape and extends in at least one of the direction in which the base portion 10 extends, and a direction intersecting the direction in which the base portion 10 extends. In the heater 1 illustrated in FIG. 1, the heating portion 30 extends in the direction in which the base portion 10 extends.

The electric resistance value per unit length of the heating portion 30 may be made substantially uniform in the direction in which the heating portion 30 extends, or it may be made different. For example, in the heating portion 30 illustrated in FIG. 1, the electric resistance value per unit length is substantially uniform in the direction in which the heating portion 30 extends. For example, the width dimension and thickness of the heating portion 30 are substantially constant. When changing the electric resistance value per unit length of the heating portion 30, it is sufficient to change at least one of the width dimension and thickness.

Also, in FIG. 1, an example where multiple heating portions 30 are provided is illustrated, but at least one heating portion 30 may be provided. In the case of providing multiple heating portions 30, the multiple heating portions 30 may be arranged side by side with a predetermined interval in a direction intersecting the direction in which the heating portion 30 extends. The length, width dimension, and thickness of the heating portion 30, and the number of heating portions 30 may be appropriately changed according to the heat generation amount required for the heater 1.

The heating portion 30 may be formed using, for example, ruthenium oxide (RuO₂), silver-palladium (Ag-Pd) alloy, silver-platinum (Ag-Pt) alloy, etc. The heating portion 30 may be formed by, for example, applying a paste-like material onto the insulation portion 20 using a screen printing method or the like, and hardening the same using a firing method or the like. In the case where the base portion 10 is formed from a material having insulating properties, the heating portion 30 may be formed by, for example, applying a paste-like material onto the surface 10a of the base portion 10 using a screen printing method or the like, and hardening the same using a firing method or the like.

The wiring portion 40 is provided on the surface 10a of the base portion 10 via the insulation portion 20. It is noted that in the case where the base portion 10 is formed from a material having insulating properties, the wiring portion 40 may be directly provided on the surface 10a of the base portion 10.

The wiring portion 40 has, for example, a terminal 41, a wiring 42, and a wiring 43.

The terminal 41 is electrically connected to the heating portion 30. The terminal 41 may be provided, for example, as a pair. For example, in the direction in which the base portion 10 extends, a pair of terminals 41 may be provided side by side near one end of the base portion 10. Further, in the direction in which the base portion 10 extends, the terminals 41 may also be provided near the ends on two sides of the base portion 10.

In this case, a pair of terminals 41 is electrically connected to a controller 203, which is described later, via a connector and external wiring, etc. Thus, in the case where the pair of terminals 41 is provided side by side near one end of the base portion 10, the wiring space around the heater 1 may be reduced, or the workability of the wiring work may be improved.

It is noted that, in the case where a conductive fluid contacts with the heater 1, a waterproof connector may be connected to the pair of terminals 41, or the connection part between the terminals 41 and the external wiring may be covered with silicone resin or the like.

The wiring 42 is, for example, provided to connect multiple heating portions 30 in series, in parallel, or in series-parallel. In FIG. 1, multiple heating portions 30 are connected in series by the wiring 42. It is noted that when only one heating portion 30 is provided, the wiring 42 may be omitted.

The wiring 43 electrically connects the terminal 41 and the heating portion 30. It is noted that the wiring 43 is not necessarily required and may be omitted. For example, the terminal 41 may be directly connected to the end of the heating portion 30. Nevertheless, in the case where the wiring 43 is provided, the configuration of the pair of terminals 41 may be arbitrarily changed. Thus, it becomes easier to set the configuration of the pair of terminals 41 considering factors such as wiring space and workability of the wiring work.

The terminal 41, wiring 42, and wiring 43 are formed using materials containing, for example, silver or copper. For example, the terminal 41, wiring 42, and wiring 43 may be formed by applying a paste-like material onto the insulation portion 20 using a screen printing method or the like, and hardening the same using a firing method or the like. It is noted that in the case where the base portion 10 is formed from a material having insulating properties, the terminal 41, wiring 42, and wiring 43 may be formed by applying a paste-like material onto the surface 10a of the base portion 10 using a screen printing method or the like, and hardening the same using a firing method or the like.

The protection portion 50 is, for example, provided on the surface 10a of the base portion 10 via the insulation portion 20. The protection portion 50 covers the heating portion 30, the wiring 42, and the wiring 43. The terminal 41 is exposed from the protection portion 50. In the case where the base portion 10 is formed from a material having insulating properties, the protection portion 50 is directly provided on the surface 10a of the base portion 10, and covers the heating portion 30, the wiring 42, and the wiring 43.

The protection portion 50, for example, has functions of insulating the heating portion 30, the wiring 42, and the wiring 43, transmitting heat generated in the heating portion 30 to the outside, and protecting the heating portion 30, the wiring 42, and the wiring 43 from external forces and the fluid to be heated.

The protection portion 50 is formed from a material that has heat resistance and insulation properties, and has high chemical stability and thermal conductivity. The protection portion 50 is formed, for example, from a glass material. In this case, the protection portion 50 may also be formed using a glass material to which a filler containing a material with high thermal conductivity, such as aluminum oxide, is added. The thermal conductivity of the glass material with added filler may be, for example, 2 [W/(m·K)] or higher. The thickness of the protection portion 50 may be, for example, substantially 20 μm to 80 μm.

The protection portion 50 may be formed, for example, by applying a paste-like material onto the insulation portion 20, the heating portion 30, the wiring 42, and the wiring 43 using a screen printing method or the like, and hardening the same using a firing method or the like. In this case, the terminal 41 is exposed from the protection portion 50. When the base portion 10 is formed from a material having insulating properties, the protection portion 50 may be formed, for example, by applying a paste-like material onto the base portion 10, the heating portion 30, the wiring 42, and the wiring 43 using a screen printing method or the like, and hardening the same using a firing method or the like.

Furthermore, the heater 1 may also be provided with a detection portion for detecting the temperature of at least one of the fluid and the heating portion 30. The detection portion may be, for example, a thermistor. The thermistor may be formed, for example, by applying a paste-like material onto the insulation portion 20 using a screen printing method or the like, and hardening the same using a firing method or the like. It is noted that in cases where the base portion 10 is formed from a material having insulating properties, the detection portion may be formed, for example, by applying a paste-like material onto at least one of the surface 10a of the base portion 10 and the surface 10b of the base portion 10 using a screen printing method or the like, and hardening the same using a firing method or the like. The material of the thermistor may include, for example, manganese and cobalt, and at least one of copper and nickel.

Further, a wiring portion electrically connected to the detection portion may be provided. The wiring portion may have a terminal and wiring, similar to the previously mentioned wiring portion 40. In this case, the protection portion 50 may cover the detection portion and the wiring. The terminal may be exposed from the protection portion 50.

Next, the effect of the heater 1 is described.

First, the effect of the heater 101 related to the comparative example is described.

FIG. 2 is a schematic view illustrating the effect of the heater 101 related to a comparative example. It is noted that in FIG. 2, to avoid complexity, only the outer shape of the heater 101 is depicted as viewed from the direction in which the heater 101 extends.

As shown in FIG. 2, when the fluid 100 is supplied to one surface of the heater 101, the fluid 100 in contact with the heater 101 flows out to the outside from the end sides of the heater 101 in a direction intersecting the direction in which the heater 101 extends. Thus, because the time during which the fluid 100 is in contact with the heater 101 becomes short, it becomes difficult to improve the heating efficiency of the fluid 100. In this case, in the case where the length of the heater 101 in the direction intersecting the direction in which the heater 101 extends is increased to improve the heating efficiency, it results in the enlargement of the heater 101.

FIG. 3 is a schematic view illustrating the effect of the heater 1.

As shown in FIG. 3, in the case where the fluid 100 is supplied to the concave curved surface of the heater 1, the fluid 100 flows along the concave curved surface of the heater 1. Thus, it becomes difficult for the fluid 100 to separate from the concave curved surface of the heater 1. As a result, an improvement in the heating efficiency of the fluid 100 may be attempted. Further, even without increasing the dimension of the heater 1 in the direction intersecting the direction in which the heater 1 extends, the contact area between the fluid 100 and the heater 1 may be increased.

In other words, in the case where the heater 1 is made according to this embodiment, it may be attempted to achieve miniaturization of the heater 1 and improvement of the heating efficiency of the fluid 100. Further, in the case where the heater 1 moves in the fluid, it may efficiently circulate the fluid 100 that contacts with the heater 1.

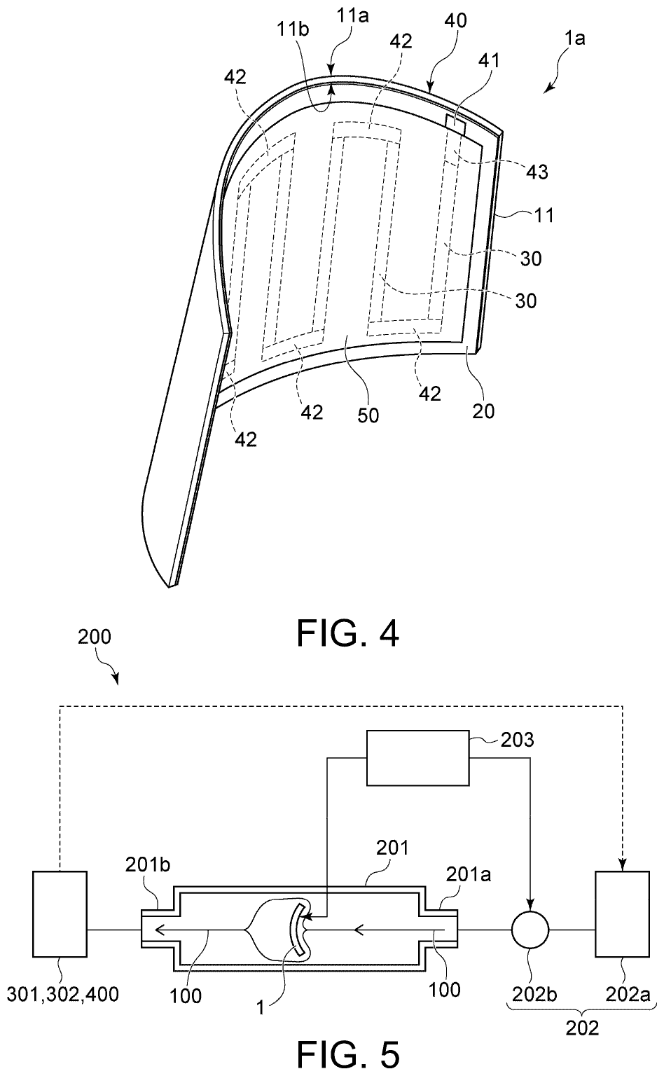

FIG. 4 is a schematic perspective view illustrating the heater 1a related to another embodiment.

As shown in FIG. 4, the heater 1a has, for example, a base portion 11, an insulation portion 20, a heating portion 30, a wiring portion 40, and a protection portion 50.

The heater 1a may be configured by providing a base portion 11 instead of the base portion 10 of the aforementioned heater 1.

As shown in FIG. 4, the base portion 11 is, for example, plate-shaped and extends in one direction. The base portion 11 has, for example, a surface 11a (corresponding to an example of a first surface) and a surface 11b (corresponding to an example of a second surface) facing the surface 11a. For example, the surface 11a may be a convex curved surface. For example, the surface 11b may be a concave curved surface.

The base portion 11 is, for example, three-dimensionally bent. For example, the surface 11a has a curved outline when projected onto a horizontal plane and a curved outline when projected onto a vertical plane. For example, the surface 11b has a curved outline when projected onto a horizontal plane and a curved outline when projected onto a vertical plane. In this case, the surface 11b is bent following the surface 11a. At least in the region where the heating portion 30 is provided, the distance (thickness) between the surface 11a and the surface 11b is substantially constant.

In the direction in which the base portion 11 extends, the dimension of one end of the surface 11a may be the same as or different from the dimension of the other end of the surface 11a. In the case of the heater 1a illustrated in FIG. 4, the dimension of one end of the surface 11a is different from the dimension of the other end of the surface 11a.

In the direction in which the base portion 11 extends, the dimension of one end of the surface 11b may be the same as or different from the dimension of the other end of the surface 11b. In the case of the heater 1a illustrated in FIG. 4, the dimension of one end of the surface 11b is different from the dimension of the other end of the surface 11b.

For example, the dimension of the part of surface 11b facing surface 11a may be made substantially the same as the dimension of the surface 11a.

For example, the base portion 11 may be formed from metal such as stainless steel or aluminum alloy, or inorganic material such as ceramics. The material of the base portion 11 may be the same as the material of the aforementioned base portion 10.

As shown in FIG. 4, in the case of heater 1a, the insulation portion 20, the heating portion 30, the wiring portion 40, and the protection portion 50 are provided on the surface 11b, which is a concave curved surface of the base portion 11. It is noted that, similar to the case of the aforementioned base portion 10, in the case where the base portion 11 is formed from an insulating material, the insulation portion 20 may be omitted.

The effect of the heater 1a may be made similar to the aforementioned effect of the heater 1.

For example, when the fluid 100 is supplied to the concave curved surface of the heater 1a, the fluid 100 flows along the concave curved surface of the heater 1a. Thus, it becomes difficult for the fluid 100 to separate from the concave curved surface of the heater 1a. As a result, an improvement in the heating efficiency of the fluid 100 may be attempted. Further, even without increasing the dimension of the heater 1a in the direction intersecting the direction in which the heater 1a extends, the contact area between the fluid 100 and the heater 1a may be increased.

In other words, in the case where the heater 1a is made according to this embodiment, it may be attempted to achieve miniaturization of the heater 1a and improvement of the heating efficiency of the fluid 100.

Further, in the case where the heater 1a moves in the fluid, it may efficiently circulate the fluid 100 that contacts with the heater 1a.

### Fluid Heating Device

In one embodiment of the disclosure, a fluid heating device 200 equipped with a heater 1 may be provided. The aforementioned description regarding the heater 1, and modified examples of the heater 1 (for example, heater 1a, or those with components added, deleted, or design-changed as appropriate by those skilled in the art, while maintaining the features of the disclosure) may all be applied to the fluid heating device 200.

It is noted that in the following, as an example, a case where a heater 1 is provided is described.

FIG. 5 is a schematic view illustrating the fluid heating device 200 related to the embodiment.

As shown in FIG. 5, the fluid heating device 200 is equipped with, for example, a heater 1, a container 201, a supply portion 202, and a controller 203.

It is noted that in FIG. 5, an example where one heater 1 is provided is illustrated, but the number of heaters 1 is not limited thereto. It is sufficient if at least one heater 1 is provided. Further, at least one of either heater 1 or heater 1a may be provided.

Further, in the case of providing at least one of the heaters 1 and 1a in plurality, multiple heaters 1 and 1a may be provided side by side in the flowing direction of the fluid 100, or multiple heaters 1 and 1a may be provided side by side in a direction intersecting the flowing direction of the fluid 100.

The container 201 presents a box-like shape. There is no particular limitation on the outer shape of the container 201. For example, the outer shape of the container 201 may be a rectangular parallelepiped. The container 201 has a space inside though which the fluid 100 flows. A supply pipe 201a is provided at one end of the container 201. A discharge pipe 201b is provided at the other end of the container 201. The supply pipe 201a and the discharge pipe 201b are facing each other. For example, the central axis of the discharge pipe 201b may be positioned on the extension line of the central axis of the supply pipe 201a.

A heater 1 is provided inside the container 201. In this case, the concave curved surface of the heater 1 may be arranged to face the supply pipe 201a. In this way, the fluid 100 may be more easily supplied to the concave curved surface of the heater 1, making it easier to obtain the effect of the heater 1 as described in FIG. 3.

The supply portion 202 is connected to the supply pipe 201a of the container 201 through piping and the like. The supply portion 202 supplies the fluid 100 to the interior of the container 201. In the case where the fluid 100 is a liquid, the supply portion 202 is equipped with, for example, a tank 202a and a pump 202b. The tank 202a stores the fluid 100. The pump 202b supplies the fluid 100 stored in the tank 202a to the interior of the container 201 through the supply pipe 201a. Further, a switching valve or a flow control valve may be provided between the pump 202b and the supply pipe 201a.

It is noted that instead of the tank 202a and the pump 202b, factory piping and the like may be connected to the supply pipe 201a of the container 201.

Further, in the case where the fluid 100 is a gas, a blowing device such as a blower may be provided instead of the tank 202a and the pump 202b.

The controller 203 controls the operation of each component provided in the fluid heating device 200. The controller 203 may be equipped with, for example, a computer, a temperature control device, and a power supply.

For example, the controller 203 controls the power applied to the heater 1, and consequently, the temperature of the fluid 100, based on signals from the detection portion provided on the heater 1. For example, the controller 203 controls the pump 202b or blower provided in the supply portion 202 to control the flow rate of the fluid 100 supplied to the interior of the container 201, and consequently, the flow rate of the heated fluid 100 discharged from the container 201.

As shown in FIG. 5, the fluid 100 supplied to the interior of the container 201 through the supply pipe 201a flows towards the discharge pipe 201b inside the container 201. Since the heater 1 is immersed in the fluid 100 flowing inside the container 201, the fluid 100 flows along the concave curved surface of the heater 1. Thus, the heat generated in the heater 1 may be directly transmitted to the fluid 100, and the separation of the fluid 100 from the concave curved surface of the heater 1 may be suppressed. As a result, an improvement in the heating efficiency of the fluid 100 may be attempted.

For example, in cases where the fluid 100 heated by the heater 1 is consumed, such as in hot water devices or hot air devices, a tank 301 for storing the heated fluid 100, or a nozzle 302 for discharging the heated fluid 100, may be connected to the discharge pipe 201b of the container 201 via piping or the like.

Further, when using the fluid 100 as a heating medium, it is possible to supply the heated fluid 100 to the component 400 that is the target of heating. For example, when the temperature of a battery mounted in an EV (electric vehicle) becomes too low, the speed of chemical reactions occurring inside the battery slows down, and the amount of electricity that may be generated decreases. In such cases, the heated fluid 100 (for example, coolant liquid, etc.) may be supplied to the outer wall of the battery and the like, so that the temperature of the battery may be maintained within an appropriate range.

Further, when using the fluid 100 as a heating medium, the fluid 100 (fluid used for heating the component 400) discharged from the component 400 may be recovered and reused. For example, as shown in FIG. 5, the fluid 100 discharged from the component 400 may be returned to the tank 202a. In this way, since the fluid 100 circulates between the component 400 and the tank 202a, it is possible to suppress the consumption amount of the fluid 100, or to suppress the power consumption of the heater 1 by reheating the high-temperature fluid 100.

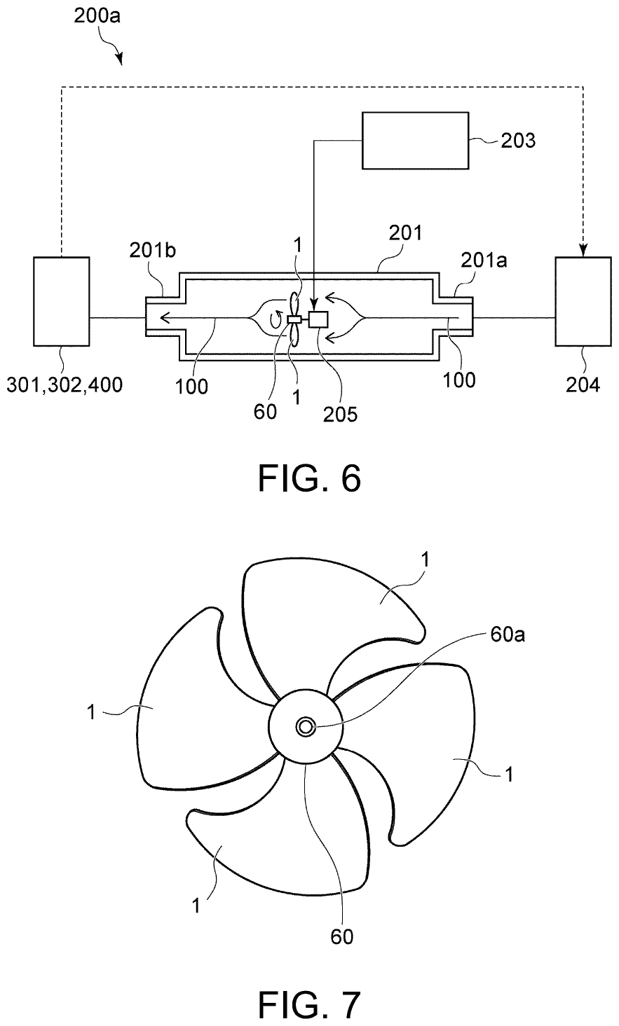

FIG. 6 is a schematic view illustrating the fluid heating device 200a related to another embodiment.

As shown in FIG. 6, the fluid heating device 200a includes, for example, a heater 1, a container 201, a supply portion 204, a driving portion 205, and a controller 203.

The supply portion 204 is connected to the supply pipe 201a of the container 201 through piping or the like. In the case where the fluid 100 is a liquid, the supply portion 204 may be, for example, a tank or the like that stores the fluid 100. In the case where the fluid 100 is a gas, the supply portion 204 may be omitted, or a filter or the like may be provided instead of the supply portion 204.

The driving portion 205 moves the position of the heater 1 in the fluid 100 through the boss 60. For example, the driving portion 205 rotates the heater 1 through the boss 60. By rotating the heater 1, the fluid 100 flows inside the container 201 from the supply pipe 201a side toward the discharge pipe 201b side. The driving portion 205 may have, for example, a motor. Further, the driving portion 205 may have a power supply brush (slip ring) or the like for supplying power to the rotating heater 1 or receiving signals from the detection portion provided on the heater 1.

FIG. 7 is a schematic view illustrating the arrangement form of the heater 1.

It is noted that in FIG. 7, an example where four heaters 1 are provided is illustrated, but the number of heaters 1 is not limited thereto. It is sufficient if at least one heater 1 is provided. Further, at least one of the heater 1 and the heater 1a may be provided at least one.

As shown in FIG. 6 and FIG. 7, the heater 1 may be provided on at least one side surface of the boss 60. In the case of providing multiple heaters 1, multiple heaters 1 may be provided at positions that are rotationally symmetric with respect to the central axis of the boss 60.

As shown in FIG. 6, the boss 60 presents a columnar shape, and a hole 60a is provided at the position of the central axis. In the hole 60a of the boss 60, for example, a rotation shaft of a motor provided in the driving portion 205 may be provided.

The controller 203 controls the operation of each component provided in the fluid heating device 200a. For example, the controller 203 controls the power applied to the heater 1, and consequently, the temperature of the fluid 100, based on signals from the detection portion provided on the heater 1. The reception of signals from the detection portion provided on the heater 1, and the application of power to the heater 1 may be performed through the power supply brush or the like provided on the driving portion 205.

For example, the controller 203 controls a motor provided in the driving portion 205 to control the flow rate of the fluid 100 flowing inside the container 201, and consequently, controls the flow rate of the heated fluid 100 discharged from the container 201.

The heated fluid 100, similar to the case of the aforementioned fluid heating device 200, may be stored in the tank 301, discharged from the nozzle 302, or supplied to the component 400 which is the target of heating. Further, similar to the case of the aforementioned fluid heating device 200, the fluid 100 discharged from the component 400 (the fluid used for heating the component 400) may be returned to the supply portion 204.

It is noted that while the above example illustrates a case where the container 201, the supply portion 202, and the supply portion 204 are provided, these may also be omitted. For example, in the atmosphere, by moving the position of the heater 1 using the driving portion 205, heated air may be directly supplied to the component 400 and the like.

Further, for example, in a liquid stored in a tank or the like, by moving the position of the heater 1 using the driving portion 205, heating and stirring of the liquid may be performed.

As described above, several embodiments of the disclosure have been illustrated, but these embodiments are presented as examples and are not intended to limit the scope of the disclosure. Novel embodiments may be implemented in various other forms, and various omissions, replacements, and changes may be made without departing from the gist of the disclosure. These embodiments and the modified examples thereof are included within the scope and gist of the disclosure, as well as within the scope of the disclosure described in the claims and its equivalents. Further, the aforementioned embodiments may be combined with each other for implementation.

The following shows appendices regarding the aforementioned embodiment.

### Appendix 1

A heater contacts with a relatively flowing fluid and heats the contacted fluid, the heater includes:
a base portion presenting a plate-like shape, having a first surface which is a convex curved surface and a second surface which faces the first surface and is a concave curved surface, and the base portion being three-dimensionally bent; and
at least one heating portion provided on at least one of the first surface side of the base portion and the second surface side of the base portion.

### Appendix 2

In the heater of Appendix 1, the second surface is bent following the first surface.

### Appendix 3

In the heater of Appendix 1 or 2, the base portion contains metal, and the heater further includes an insulation portion provided between the heating portion and the base portion.

### Appendix 4

A fluid heating device that includes:
a boss;
at least one heater according to any one of Appendices 1 to 3 provided on the boss; and
a driving portion moving a position of the heater in fluid via the boss.

### Appendix 5

A fluid heating device that includes:
a container having a space inside through which fluid flows; and
at least one heater according to any one of Appendices 1 to 3 provided inside the container.

What is claimed is:

1. A heater, which is a heater that contacts with a relatively flowing fluid and heats the contacted fluid, comprising:
a base portion presenting a plate-like shape, having a first surface which is a convex curved surface and a second surface which faces the first surface and is a concave curved surface, and the base portion being three-dimensionally bent; and
at least one heating portion provided on at least one of the first surface side of the base portion and the second surface side of the base portion.

2. The heater according to claim 1, wherein the second surface is bent following the first surface.

3. The heater according to claim 1, wherein the base portion contains metal, and
the heater further comprises an insulation portion provided between the heating portion and the base portion.

4. A fluid heating device, comprising:
a boss;
at least one heater according to claim 1 provided on the boss; and
a driving portion moving a position of the heater in fluid via the boss.

5. A fluid heating device, comprising:
a container having a space inside through which fluid flows; and
at least one heater according to claim 1 provided inside the container.
